(19) United States
(12) Patent Application Publication
(10) Pub. No.: US 2026/0307224 A1
(43) Pub. Date: Oct. 8, 2026

(54) Gate Socket Attachment Device

(71) Applicants: Carey Tanner, Boston, GA (US); Patricia Tanner, Boston, GA (US)

(72) Inventors: Carey Tanner, Boston, GA (US); Patricia Tanner, Boston, GA (US)

(21) Appl. No.: 18/318,814

(22) Filed: May 17, 2023

Related U.S. Application Data
(60) Provisional application No. 63/405,187, filed on Sep. 9, 2022.

(51) Int. Cl. B25B 23/00; B25B 13/06

(52) U.S. Cl. CPC B25B 23/0035; B25B 13/06

(57) ABSTRACT

The present invention relates to a gate socket attachment device primarily comprised of a body, a level, at least one hinge attachment member, at least one fastener, at least one socket attachment member, and at least one universal opening. The device may be attached to a plurality of power tools by attaching the socket attachment member to the power tool. Further, the L-shaped gate hinge can be securely fastened into the hinge attachment member allowing for effortless screwing of the gate hinge. The gate socket attachment device provides a way for individuals to use a power tool to screw in L-shaped gate hinges.

### CROSS-REFERENCE TO RELATED APPLICATION

The present application claims priority to, and the benefit of, U.S. Provisional Application No. 63/405,187, which was filed on Sep. 9, 2022, and is incorporated herein by reference in its entirety.

### FIELD OF THE INVENTION

The present invention relates generally to the field of socket attachments. More specifically, the present invention relates to a gate socket attachment device primarily comprised of a body, at least one level, at least one hinge attachment member, at least one fastener, at least one socket attachment member, and at least one universal opening. The device may be attached to a plurality of power tools by attaching the socket attachment member to the power tool. Further, the L-shaped gate hinge can be securely fastened into the hinge attachment member allowing for effortless screwing of the gate hinge. Accordingly, the present disclosure makes specific reference thereto. Nonetheless, it is to be appreciated that aspects of the present invention are also equally applicable to other like applications, devices, and methods of manufacture.

### BACKGROUND

Manually screwing in any type of screw can be difficult and tedious work, including gate hinges. For individuals with physical limitations such as arthritis, this task can be extremely painful and can further injure the individual as there is no easy way to screw in a gate hinge. Because gate hinges are in the shape of an “L”, individuals cannot use common screw drivers or other tools to screw in a gate hinge. Further, no drill bits or impact wrench sockets are designed to fit the “L” shape of gate hinges.

Therefore, there exists a long-felt need in the art for an attachment for a power tool that can easily screw in L-shaped gate hinges with minimal effort. Further, there exists a long-felt need in the art for a gate socket attachment device that can be used with L-shaped gate hinges. There also exists a long-felt need in the art for a gate socket attachment device that can be used with a variety of power tools, such as an impact wrench or a drill. In addition, there exists a long-felt need in the art for a gate socket attachment device that allows individuals to effortlessly screw in gate hinges using a power tool.

The subject matter disclosed and claimed herein, in one embodiment thereof, comprises a gate socket attachment device. The device is primarily comprised of a body, at least one socket attachment member, at least one hinge attachment member, and at least one fastener. The socket attachment member is comprised of at least one opening that is a universal socket adaptor that can be attached to any power tool attachment member regardless of the shape. The body of the device is designed to receive an L-shaped gate hinge such that the hinge can be screw into a surface using the power tool attached to the device.

In this manner, the gate socket attachment device of the present invention accomplishes all of the foregoing objectives and provides a novel gate socket attachment device that provides a way for individuals to use a power tool to screw in L-shaped gate hinges. In addition, the device provides users with a way to screw in L-shaped gate hinges without wasting large amounts of time screwing the hinges in by hand.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a gate socket attachment device. The device is comprised of a body, at least one hinge attachment member, at least one socket attachment member, and at least one fastener. The body of the device is preferably manufactured from a metal material. In one embodiment, the device may be manufactured from a galvanized metal to prevent the metal from rusting over time. In another embodiment, the device may have a protective coating to further protect the metal. In one embodiment, the device may be comprised of at least one level positioned on the side of the body. The level will ensure that the user is screwing in the L-shaped gate hinge straight in order to not have to redo the task.

The device is comprised of at least one socket attachment member. In one embodiment, the socket attachment member may have an opening that the power tool attachment member slides into to attach the device to the power tool. In the preferred embodiment, the opening is a universal socket adaptor to allow any size power tool attachment member to attach to the device. In a differing embodiment, the socket attachment member functions as a drill bit, in that it slides into the mouth of the power tool and the power tool clasps over the socket attachment member. This holds the device in place throughout use.

The device also is comprised of at least one hinge attachment member. In the preferred embodiment, the hinge attachment member is an L-shape that allows for an L-shaped gate hinge to be placed within the device. The hinge attachment member may be comprised of at least one fastener. The fastener allows for the L-shaped gate hinge to be securely attached within the device such that it does not fall out during use.

Accordingly, the gate socket attachment device of the present invention is particularly advantageous as it provides individuals with a convenient way to screw in L-shaped gate hinges without using ample amounts of physical labor. Further, the device provides a gate socket attachment member that can be attached to a plurality of power tools for more versatile use. In this manner, the gate socket attachment device overcomes the limitations of existing socket attachments known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a gate socket attachment device of the present invention while screwing an L-shaped gate hinge into a surface in accordance with the disclosed architecture;

FIG. 2 illustrates an exploded view of one potential embodiment of a gate socket attachment device of the present invention in accordance with the disclosed architecture; and

FIG. 3 illustrates a flowchart of one potential method of using one potential embodiment of the gate socket attachment device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an attachment for a power tool that can easily screw in L-shaped gate hinges with minimal effort. Further, there exists a long-felt need in the art for a gate socket attachment device that can be used with L-shaped gate hinges. There also exists a long-felt need in the art for a gate socket attachment device that can be used with a variety of power tools, such as an impact wrench or a drill. In addition, there exists a long-felt need in the art for a gate socket attachment device that allows individuals to effortlessly screw in gate hinges using a power tool.

The present invention, in one exemplary embodiment, is comprised of a gate socket attachment device. The device is primarily comprised of a body, at least one socket attachment member, at least one hinge attachment member, and at least one fastener. The device allows for the user to effortlessly screw in L-shaped gate hinges using a variety of power tools. In the preferred embodiment, the device is comprised of a level positioned on the body of the device to further ensure that the L-shaped gate hinge is being screwed in straight.

In the preferred embodiment, the socket attachment member is comprised of at least one opening that is a universal socket adaptor that can be attached to any power tool attachment member regardless of the shape. Further, the hinge attachment member may be comprised of at least one fastener. This fastener further helps to attach the L-shaped gate hinge to the hinge attachment member to ensure that the L-shaped gate hinge does not come loose while in use.

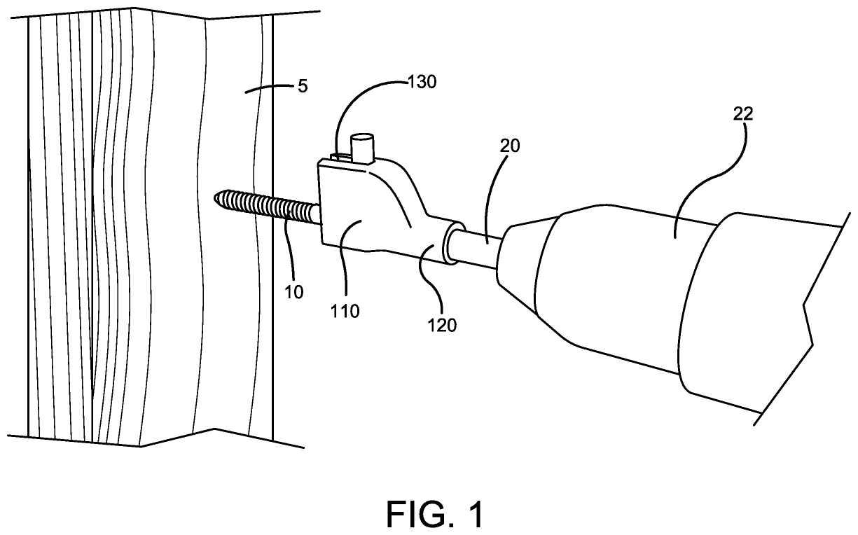

Referring initially to the drawings, FIG. 1 illustrates a perspective view of one potential embodiment of a gate socket attachment device 100 of the present invention while screwing an L-shaped gate hinge 10 into a surface 5 in accordance with the disclosed architecture. The device 100 is comprised of a body 110, at least one hinge attachment member 130, at least one socket attachment member 120, and at least one fastener 132.

The body 110 of the device is preferably manufactured from a metal material. There are a plurality of metal materials that may be used such as, but not limited to, iron, stainless steel, aluminum, copper, tin, platinum, titanium, chromium, vanadium, carbon steel, tungsten, etc. In one embodiment, the device 100 may be manufactured from a galvanized metal to prevent the metal from rusting over time. In another embodiment, the device 100 may have a protective coating to further protect the metal.

In one embodiment, the device 100 may be comprised of at least one level 112 positioned on the side of the body 110. The level 112 ensures that the user is properly installing the L-shaped gate hinge 10, so as to not have to repeat the installation process. The level may be any level type known in the art such as, but not limited to, a carpenter level, bubble level, line level, torpedo level, pocket level, bull's eye level, post level, angle level, cross-check level, mason level, water level, spirit level, etc.

The device 100 is also comprised of at least one socket attachment member 120. In one embodiment, the socket attachment member 120 may have at least one opening 122 that the power tool attachment member 20 slides into to attach the device 100 to the power tool. In the preferred embodiment, the opening is a universal socket adaptor to allow any size power tool attachment member 20 to attach to the device 100. In differing embodiments, the opening 122 may be any size or shape known in the art that accommodates any power tool attachment member 20 known in the art. In a differing embodiment, the socket attachment member 120 functions as a drill bit, in that it slides into the mouth of a power tool such that the power tool clasps over the socket attachment member 120 to hold the device 100 in place throughout use.

The device 100 also is comprised of at least one hinge attachment member 130 that is preferably in the form of a groove of the body 110. In the preferred embodiment, the hinge attachment member 130 is an L-shape that allows for an L-shaped gate hinge 10 to be received by the body 110. In differing embodiments, the hinge attachment member 130 may be any size or shape known in the art that attaches any size, shape, or configuration of gate hinges 10 or any other hinge type known in the art.

In one embodiment, the hinge attachment member 130 may be comprised of at least one fastener 132. The fastener 132 allows for the L-shaped gate hinge 10 to be securely attached within the member 130 such that it does not fall out during use. In the preferred embodiment, the fastener 132 is a magnetic fastener. There are a plurality of magnets that may be used such as, but not limited to: neodymium iron boron magnets, samarium cobalt magnets, alnico magnets, ceramic magnets, ferrite magnets, etc.

In another embodiment, the fastener 132 is in the form of a rubber sleeve that provides for a tight hold on the L-shaped gate hinge 10. There are a plurality of rubbers that may be used such as, but not limited to: natural rubbers, neoprene rubber elastomer, silicone rubber elastomer, ethylene propylene diene monomer rubber, butyl rubber, nitrile rubber, buna-n rubber, styrene-butadiene rubber elastomers, viton rubber elastomer, diaphragm rubber, thermoplastic rubber, etc. In differing embodiments, the fastener 132 may be any fastener known in the art.

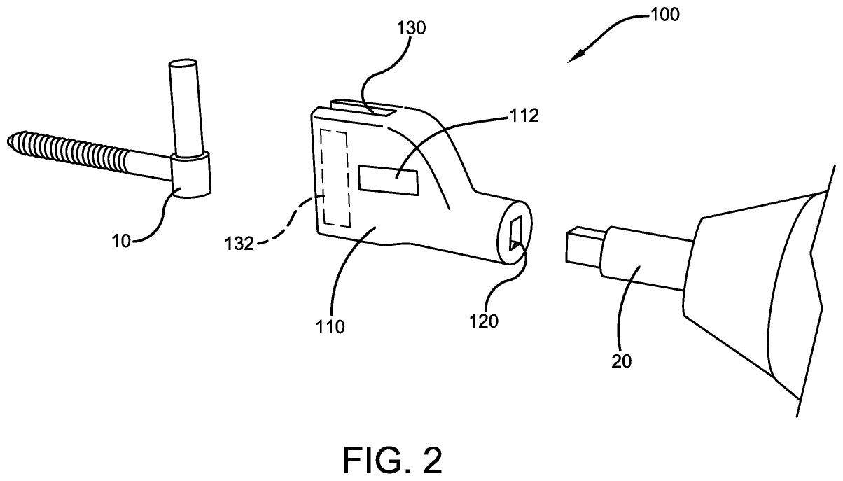

FIG. 2 illustrates an exploded view of one potential embodiment of a gate socket attachment device 100 of the present invention in accordance with the disclosed architecture. The device 100 further attaches to the power tool attachment member 20 via the socket attachment member 120. In one embodiment, the socket attachment member 120 may be comprised of a magnetic fastener to provide an even more secure connection. There are a plurality of magnets that may be used such as, but not limited to: neodymium iron boron magnets, samarium cobalt magnets, alnico magnets, ceramic magnets, ferrite magnets, etc. The device 100 is further attached to the L-shaped gate hinge 10 via the hinge attachment member 130. The device 100 provides a convenient way to screw in L-shaped gate hinges 10 without wasting time or energy.

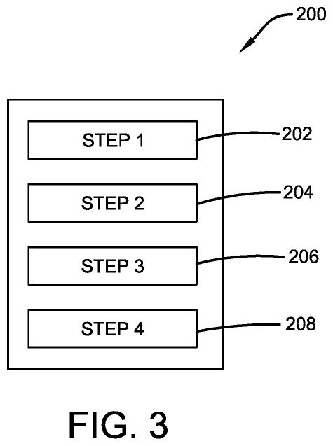

FIG. 3 illustrates a flowchart of one potential method 200 of using one potential embodiment of the gate socket attachment device 100 of the present invention in accordance with the disclosed architecture. First, a user attaches the device 100 to a power tool 22 by attaching the socket attachment member 120 to the power tool attachment member 20 [Step 202]. Then, a user places the L-shaped gate hinge 10 into the device 100 by placing the L-shaped gate hinge 10 into the hinge attachment member 130 [Step 204]. Next, a user will align the L-shaped gate hinge 10 on the chosen surface 5 using the level 112 positioned on the body 110 of the device 100 [Step 206]. Then, a user presses toward the surface 5 and engages the power tool 22 to screw the hinge 10 into the surface [Step 208]. Finally, when a user is done screwing the hinge 10 to the surface 5 and the hinge 10 is in the upright position, the user pulls the power tool 22 and the device 100 away from the L-shaped gate hinge 10 to detach the device 100 from the L-shaped gate hinge 10 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “gate socket attachment device” and “device” are interchangeable and refer to the gate socket attachment device 100 of the present invention.

Notwithstanding the foregoing, the gate socket attachment device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the gate socket attachment device 100 as shown in the FIGS. are for illustrative purposes only, and that many other sizes and shapes of the gate socket attachment device 100 are well within the scope of the present disclosure. Although the dimensions of the gate socket attachment device 100 are important design parameters for user convenience, the gate socket attachment device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gate socket attachment device comprising:
a body;
a socket attachment member; and
a hinge attachment member.

2. The gate attachment member of claim 1, wherein the socket attachment member is comprised of an opening.

3. The gate attachment member of claim 2 further comprises a universal socket adaptor.

4. The gate attachment member of claim 1 further comprised of a level.

5. The gate attachment member of claim 4, wherein the level is positioned on a side of the body.

6. The gate attachment member of claim 4, wherein the level is comprised of a carpenter level, a bubble level, a line level, a torpedo level, a pocket level, a bull's eye level, a post level, an angle level, a cross-check level, a mason level, a water level, or a spirit level.

7. The gate attachment member of claim 1, wherein the hinge attachment member is comprised of a fastener.

8. The gate attachment member of claim 7, wherein the fastener is comprised of a magnetic fastener.

9. The gate attachment member of claim 8, wherein the magnetic fastener is a comprised of a neodymium iron boron magnet, a samarium cobalt magnet, an alnico magnet, a ceramic magnet, or ferrite magnet.

10. The gate attachment member of claim 1, wherein the body is comprised of a galvanized metal.

11. A gate socket attachment device comprising:
a body;
a level;
a socket attachment member having an opening; and
a hinge attachment member comprised of a fastener.

12. The gate attachment member of claim 11, wherein the hinge attachment member is comprised of a generally L-shaped groove.

13. The gate attachment member of claim 11, wherein the socket attachment member is comprised of a magnetic fastener.

14. The gate attachment member of claim 13, wherein the magnetic fastener is comprised of a neodymium iron boron magnet, a samarium cobalt magnet, an alnico magnet, a ceramic magnet, or ferrite magnet.

15. The gate attachment member of claim 11, wherein the body is comprised of a metal material.

16. The gate attachment member of claim 15, wherein the metal material is comprised of an iron, a stainless steel, an aluminum, a copper, a tin, a platinum, a titanium, a chromium, a vanadium, a carbon steel, or a tungsten materials.

17. The gate attachment member of claim 15, wherein the metal material is comprised of a galvanized metal.

18. The gate attachment member of claim 11, wherein the fastener is comprised of a rubber sleeve fastener.

19. The gate attachment member of claim 18, wherein the rubber sleeve fastener is comprised of a natural rubber, a neoprene rubber elastomer, a silicone rubber elastomer, an ethylene propylene diene monomer rubber, a butyl rubber, a nitrile rubber, a buna-n rubber, a styrene-butadiene rubber elastomers, a viton rubber elastomer, a diaphragm rubber, or a thermoplastic rubber material.

20. The method of using a gate socket attachment device, the method comprising the steps of:
attaching a socket attachment member of a gate socket attachment device to a power tool attachment member of a power tool;
attaching an L-shaped gate hinge to a hinge attachment member of the gate socket attachment device;
aligning the L-shaped gate hinge via a level to a surface;
screwing the L-shaped gate hinge into the surface by powering on the power tool and pressing the L-shaped gate hinge into a surface; and
removing the gate socket attachment member and the power tool from the L-shaped gate hinge after the L-shaped gate hinge has been screwed into the surface.
